(19) United States
(12) Patent Application Publication
(10) Pub. No.: US 2015/0046816 A1
(43) Pub. Date: Feb. 12, 2015

(54) DISPLAY OF VIDEO CONTENT BASED ON A CONTEXT OF USER INTERFACE

(71) Applicant: International Business Machines Corporation, Armonk, NY (US)

(72) Inventors: Gary D. Cudak, Creedmoor, NC (US); Lydia M. Do, Raleigh, NC (US); Christopher J. Hardee, Raleigh, NC (US); Adam Roberts, Moncure, NC (US)

(73) Assignee: International Business Machines Corporation, Armonk, NY (US)

(21) Appl. No.: 13/960,146

(22) Filed: Aug. 6, 2013

(51) Int. Cl. G06F 3/0482

(52) U.S. Cl. CPC G06F 3/0482
USPC 715/719

(57) ABSTRACT

Systems and methods for display of video content based on a context of user interface are disclosed. According to an aspect, a method includes displaying video content at a computing device. The method also includes determining contexts based on the displayed video content. For example, a context of video content may be determined based on metadata that indicates a subject of a portion of the video content. Further, the method includes receiving user selection of at least one of the contexts. The method includes presenting, at the computing device, one or more video frames associated with the user selection.

### BACKGROUND

1. Field of the Invention

The present invention relates to video content, and more specifically, to the display of video content based on a context of user interface.

2. Description of Related Art

Many people enjoy using their computing devices to view videos or other media content. Currently, video sharing services available through the Internet allow users to upload, view, and share videos. Users may access websites provided by such services to search for videos of interest. As an example, a user may enter a word or phrase to search for videos. The website may subsequently display a title and/or frame of one or more videos based on the search query. Display of the title and/or frame is intended to provide the user with a preview of the video so that the user can decide whether to select the video for play.

A preview video frame is typically selected by a video sharing service or the person who uploaded the video to the video sharing website. The selected frame is intended to provide a prospective viewer with information about the video's content. Although the selected frame can be helpful to a prospective viewer, it is desired to provide improved techniques for suggesting videos for play.

### BRIEF SUMMARY

In accordance with one or more embodiments of the present invention, systems and methods for display of video content based on a context of user interface are disclosed. According to an aspect, a method includes displaying video content at a computing device. The method also includes determining contexts based on the displayed video content. For example, a context of video content may be determined based on metadata that indicates a subject of a portion of the video content. Further, the method includes receiving user selection of at least one of the contexts. The method includes presenting, at the computing device, one or more video frames associated with the user selection.

### BRIEF DESCRIPTION OF THE SEVERAL VIEWS OF THE DRAWINGS

FIG. 1 is a block diagram of an example system for display of video content based on a context of user interface in accordance with embodiments of the present invention;

FIG. 2 is a flow chart of an example method for display of video content based on a context of user interface in accordance with embodiments of the present invention; and

FIG. 3 is a screen display showing an example browser playing a video made available by a web server in accordance with embodiments of the present invention.

### DETAILED DESCRIPTION

As described herein, there are various embodiments and aspects of the present invention. Particularly, disclosed herein are systems and methods for display of video content based on a context of user interface. As an example, a user may operate a computing device to play and preview video content residing on his or her computing device or provided by another computing device. The user's computing device may determine a context of user interface and identify one or more portions of video content associated with the context. For example, a video content portion may be one or more frames of a video. Subsequently, the video content portion may be displayed to the user for previewing the video content to the user and for assisting the user in determining whether to play the video content.

As referred to herein, the term “computing device” should be broadly construed. It can include any type of device capable of presenting a media item to a user. For example, the computing device may be an e-book reader configured to present an e-book to a user. In an example, a computing device may be a mobile device such as, for example, but not limited to, a smart phone, a cell phone, a pager, a personal digital assistant (PDA, e.g., with GPRS NIC), a mobile computer with a smart phone client, or the like. In another example, a computing device can also include any type of conventional computer, for example, a desktop computer or a laptop computer. A typical computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on a mobile device, the examples may similarly be implemented on any suitable computing device, such as a laptop or desktop computer.

As referred to herein, the term “video content” should be broadly construed as any suitable electronic medium for storing video. The video may be presented to a user via any suitable computing device. For example, video may be presented via Adobe Systems Incorporated's flash video technology, hypertext markup language (HTML) technology, or the like. A video may include audio and multiple frames of video.

As referred to herein, a “user interface” is generally a system by which users interact with a computing device. An interface can include an input for allowing users to manipulate a computing device, and can include an output for allowing the system to present information (e.g., e-book content) and/or data, indicate the effects of the user's manipulation, etc. An example of an interface on a computing device includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. The display object can be displayed on a display screen of a computing device and can be selected by and interacted with by a user using the interface. In an example, the display of the computing device can be a touch screen, which can display the display icon. The user can depress the area of the display screen at which the display icon is displayed for selecting the display icon. In another example, the user can use any other suitable interface of a computing device, such as a keypad, to select the display icon or display object.

Operating environments in which embodiments of the present subject matter may be implemented are also well-known. In a representative embodiment, a computing device is connectable (for example, via WAP) to a transmission functionality that varies depending on implementation. Thus, for example, where the operating environment is a wide area wireless network (e.g., a 2.5G network, a 3G network, or a 4G network), the transmission functionality comprises one or more components such as a mobile switching center (MSC) (an enhanced ISDN switch that is responsible for call handling of mobile subscribers), a visitor location register (VLR) (an intelligent database that stores on a temporary basis data required to handle calls set up or received by mobile devices registered with the VLR), a home location register (HLR) (an intelligent database responsible for management of each subscriber's records), one or more base stations (which provide radio coverage with a cell), a base station controller (BSC) (a switch that acts as a local concentrator of traffic and provides local switching to effect handover between base stations), and a packet control unit (PCU) (a device that separates data traffic coming from a mobile device). The HLR also controls certain services associated with incoming calls. Of course, embodiments in accordance with the present disclosure may be implemented in other and next-generation mobile networks and devices as well. The mobile device is the physical equipment used by the end user, typically a subscriber to the wireless network. Typically, a mobile device is a 2.5G-compliant device, 3G-compliant device, or 4G-compliant device that includes a subscriber identity module (SIM), which is a smart card that carries subscriber-specific information, mobile equipment (e.g., radio and associated signal processing devices), a user interface (or a man-machine interface (MMI)), and one or more interfaces to external devices (e.g., computers, PDAs, and the like). The computing device may also include a memory or data store.

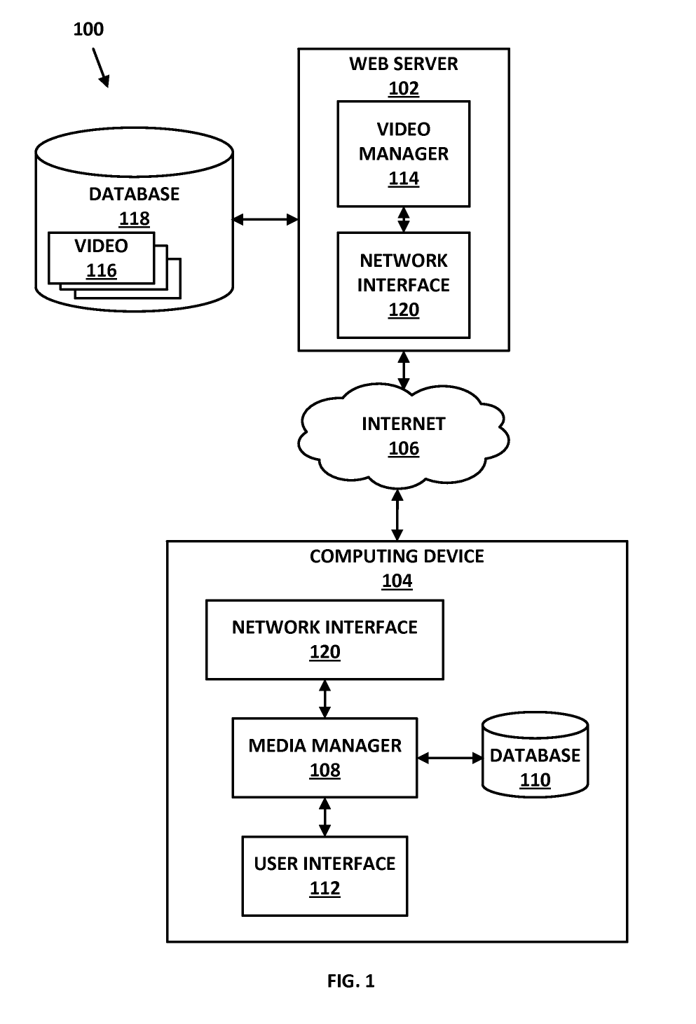

The presently disclosed subject matter is now described in more detail. For example, FIG. 1 illustrates a block diagram of an example system 100 for display of video content based on a context of user interface in accordance with embodiments of the present invention. Referring to FIG. 1, the system 100 includes a web server 102 and a computing device 104 communicatively connected via the Internet 106 by use of any suitable communications technology (e.g., wide area network (WAN), mobile network, local area network (LAN), and the like) and communications protocol (e.g., HTTP, HTTPS, and the like). Although in this example the web server 102 and the computing device 104 are connected via the Internet 106, these devices may alternatively be connected via any type of suitable network connection. The computing device 104 may be any suitable type of computing device capable of presenting media content, such as video content, a website, text content, a computing device application, and the like, to a user. This representation of the web server 102 and the computing device 104 is meant to be for convenience of illustration and description, and it should not be taken to limit the scope of the present subject matter as one or more functions may be combined. Typically, these components are implemented in software (as a set of process-executable computer instructions, associated data structures, and the like). One or more of the functions may be combined or otherwise implemented in any suitable manner (e.g., in hardware, in firmware, in software, combinations thereof, or the like).

The computing device 104 may include a media manager 108 for managing storage of one or more media items in a database 110 and for controlling presentation of a media item to a user. The computing device 104 may include a user interface 112 configured to receive user input and to present content to a user. For example, the user interface 112 may include a display capable of presenting video content to a user. The database 110 may be a suitable memory device.

The web server 102 is shown as a single device but this is not a requirement. One or more programs, processes, or other code may comprise the server and be executed on one or more machines in one or more networked locations. The web server 102 may include a video manager 114 configured to access videos 116 stored in a database 118 for communication to computing devices via the Internet 106. The web server 102 and the computing device 104 may each include a network interface 120 configured to interface the Internet 106.

The operation of the system 100 can be described by the following example. As shown in FIG. 1, the web server 102 and the computing device 104 each include various functional components and associated data stores to facilitate the operation and functions disclosed herein. However, it is noted that the operation and functions in accordance with embodiments of the present invention may be implemented at a single computing device or multiple computing devices, or using system components other than as shown in FIG. 1.

A user of the computing device 104 may use an application residing on the computing device 104 to request and query for video content from the web server 102, and to control the presentation and play of video content stored in its database 110. The application may reside on the computing device 104 and be a part of the media manager 108. The user may, for example, input commands into the user interface 112 for opening a web site provided by the web server 102 and for playing and querying for video content made available by the web site.

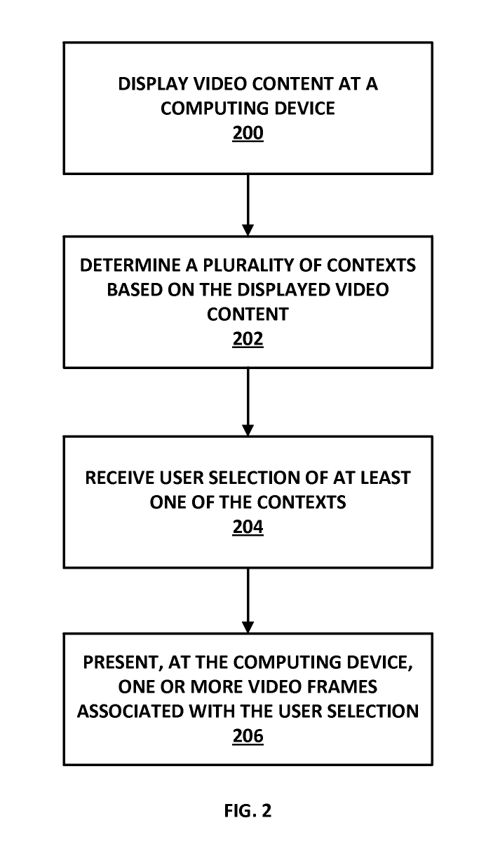

FIG. 2 illustrates a flow chart of an example method for display of video content based on a context of user interface in accordance with embodiments of the present invention. The method of FIG. 2 is described with respect to the example system 100 shown in FIG. 1, although the method may be implemented by any suitable system or computing device. The steps of FIG. 2 may be implemented entirely, or in part, by the media manager 108 and/or video manager 114 shown in FIG. 1. The media manager 108 and video manager 114 may each be implemented by software, hardware, firmware, or combinations thereof.

Referring to FIG. 2, the method includes displaying 200 video content at a computing device. For example, the media manager 108 shown in FIG. 1 may monitor interactions of a user with the computing device 104. An application residing on the computing device 104 may provide data indicating a context of user interaction. For example, a media player may be playing video content via the user interface 112. The video content may be displayed within a web browser of the computing device. More particularly, for example, the video content may be provided to the computing device 104 by a web server of a video sharing service via the Internet 106.

The method of FIG. 2 includes determining 202 a plurality of contexts based on the displayed video content. Continuing the aforementioned example, contexts of the displayed video content may be determined based on metadata of the video content that indicates a subject of different portions of the displayed video content. The metadata may include descriptive data associated with the displayed video content. The descriptive data may be text. As an example, descriptive data may include the title of the video content, description of portions of the video content, the like, or combinations thereof.

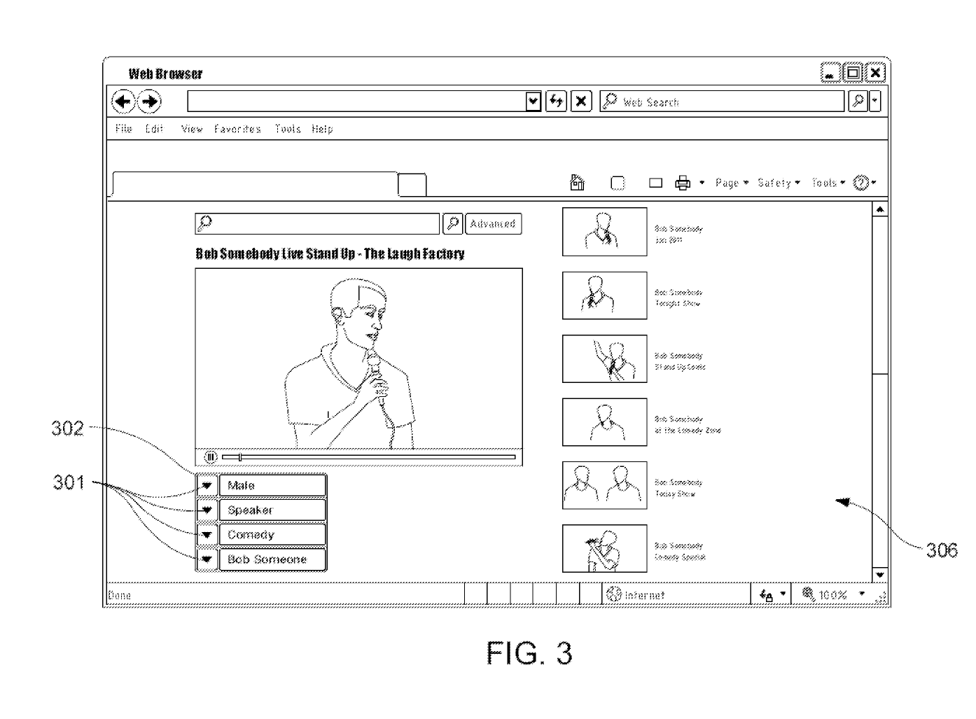

The method of FIG. 2 includes receiving 204 user selection of at least one of the contexts. Continuing the aforementioned example, the media manager 108 may control the user interface 112 to display or otherwise present identification of the contexts for user selection. As an example, FIG. 3 illustrates a screen display showing an example browser playing a video made available by a web server in accordance with embodiments of the present invention. Referring to FIG. 3, the browser is playing a video 300, a frame of which is shown in FIG. 3. Box 302 indicates multiple contexts associated with the video being played. More particularly, the box 302 indicates that the contexts of the video, in this example, are “male,” “speaker,” “comedy,” and “Bob Someone”. This may be information provided in metadata associated with the video, or based upon analysis of the video. A topic of the video or portions of the video (e.g., frames) may be determined by parsing and determining content in the video and identifying content within one or more frames of the video. The user may then select one or more of the contexts by suitable use of the user interface 112.

Further, for example, a user may interact with icons 304 associated with each subject to modify them for selecting another subject to change a context and achieve a desired result for search of other content. For example, a user may select or identify a subject by selection of the icon 304 and entering text or selecting a subject, and the selected subject may be used together with context information for identifying a portion of a video associated with a video being presented.

Returning to FIG. 2, the method includes presenting 206, at the computing device, one or more video frames associated with the user selection. Continuing the aforementioned example, the contexts of the displayed video content may include descriptive data that is compared to descriptive data associated with one or more other video content. Further, in this example, one or more video frames for display may be identified based on the comparison. The identified frame(s) may be those frames having a matching description or similar description to the description of the contexts of the displayed video content. Returning to the example of FIG. 3, the web browser of FIG. 3 may show multiple frames of the videos 116 at an area 306. The displayed frames may be those frames having a subject similar to or the same as a context or subject of the video 300.

In accordance with embodiments of the present invention, a computing device may determine a subject of media content being implemented thereon. For example, the media manager 108 may determine the context based on open applications, websites, browsers and tabs, combinations thereof, or the like. For example, a title of a word processing document or other content of the document may indicate a context of user interaction with the computing device 104. In another example, the context may be determined based on a link accessed from a web site advertising a particular type of item or product. In another example, context information may be obtained by one or more open files on the computing device 104 and/or one or more open tabs in a browser. One or more video frames may be determined or identified based on one or more of these contexts. These identified video frames may be displayed to a user, such as displayed in the area 306 shown in FIG. 3. Other example contexts include, but are not limited to, a history or profile of a user, subscription information of a user, information about channels set for a user on a video sharing service, and the like.

In accordance with embodiments of the present invention, an identified portion of video content displayed to a user may be updated or changed based on a change in context. For example, a user viewing the video 300 shown in FIG. 3 may select a different video for display, thus changing a context of user interaction. In this case, the video frames displayed within area 306 may change to or be replaced by video frames having a subject that is the same or similar to the subject of the new video selected for display by the user. It is noted that updates to displayed portions of video content may be updated continuously as context changes or as time changes. For example, updates may be in a cycle and the number of frames may be function of the least common denominator (e.g., which frame has the fewest context matching a key frame); may be tied to a predefined refresh rate; or may be an average of the number of key frames.

In an example scenario, determined contexts of display video content may be used as filter criteria for recommended video content. For example, a video sharing service may recommend one or more videos for presentation to a user via a web browser. In this case, the recommended videos may be filtered by the determined contexts. Only recommended videos having a subject matching the determined contexts or being similar to the determined contexts may be presented via the computing device, thus providing a filter for recommended video content.

In an example scenario, a user may be using his or her computing device to view a video provided by a server of a video sharing service. The video may show basketball highlights for a particular player. For example, this video may be the video 300 shown in FIG. 3. A media manager, such as media manager 108 shown in FIG. 1, may identify frames of videos associated with a subject (e.g., the particular player) of the video being played. Subsequently, the user may select to play another video showing particular basketball plays, such as a dunk. In view of the change, the context may be considered the subject of the previously-played video (e.g., the particular basketball player) along with the subject of the currently-playing video (e.g., the dunk play). The media manager 108 may then control the display to display frames, in the area 306 of FIG. 3, of different videos showing the particular player performing a dunk play.

In accordance with embodiments of the present invention, different portions of video content may include data describing the subject matter of the respective portion. For example, descriptive data may include text that describes one or more frames of a video. This descriptive data in two different videos may be used to determine whether a portion of one video is associated with a portion of another video. In the case of the text being the same, similar, or otherwise matching in the two portions, the video portions may be considered to be associated. When one video is displayed that is associated with another video, the identified frame of the other video may be displayed or otherwise presented to a user via a user interface.

In an example scenario, a user may select one or more contexts. The user-selected context(s) may be used alone or in combination with other determined contexts. In this case, the context(s) may be compared to video content to determine a match or similarity. If there is a match or sufficient similarity, one or more frames of the matching or similar video content may be displayed or otherwise presented via a user interface. If a match does not exist, some other criteria may be used to present a video, such as a preview video, to a user.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a computing device configured to:
display video content at the computing device;
determine a plurality of contexts based on the displayed video content;
receive user selection of at least one of the contexts; and
present, at the computing device, one or more video frames associated with the user selection.

2. The system of claim 1, wherein the computing device is configured to determine a plurality of contexts based on metadata that indicates a subject of different portions of the displayed video content.

3. The system of claim 1, wherein the computing device is configured to:
determine a subject of media content being implemented by the computing device; and
determine the one or more video frames based on the subject of media content and the user selection.

4. The system of claim 3, wherein the media content comprises one of a website, video content, text content, and a computing device application.

5. The system of claim 1, wherein the computing device is configured to present, at the computing device, identification of the plurality of contexts for user selection.

6. The system of claim 1, wherein the one or more video frames are video frames of video content other than the displayed video content.

7. The system of claim 1, wherein the computing device is configured to:
determine descriptive data associated with the displayed video content;
compare the descriptive data associated with the displayed video content with descriptive data associated with one or more other video content; and
identify the one or more video frames based on the comparison.

8. The system of claim 1, wherein the computing device is configured to replace one or more other currently-displayed video frames with the one or more video frames.

9. The system of claim 1, wherein the computing device is configured to:
receive user-identification of a subject; and
identify the one or more video frames based on the subject and the user selection.

10. The system of claim 1, wherein the computing device is configured to display the video content within a web browser of the computing device.

11. The system of claim 10, wherein the computing device is configured to display the one or more video frames within the web browser.

12. The system of claim 1, wherein the computing device is configured to use the determined contexts to recommend new videos containing the determined context.

13. A computer program product for display of video content, said computer program product comprising:
a computer readable storage medium having computer readable program code embodied therewith, the computer readable program code comprising:
computer readable program code configured to display video content at the computing device;
computer readable program code configured to determine a plurality of contexts based on the displayed video content;
computer readable program code configured to receive user selection of at least one of the contexts; and
computer readable program code configured to present, at the computing device, one or more video frames associated with the user selection.

14. The computer program product of claim 13, further comprising computer readable program code configured to determine a plurality of contexts based on metadata that indicates a subject of different portions of the displayed video content.

15. The computer program product of claim 13, further comprising computer readable program code configured to:
determine a subject of media content being implemented by the computing device; and
determine the one or more video frames based on the subject of media content and the user selection.

16. The computer program product of claim 15, wherein the media content comprises one of a website, video content, text content, and a computing device application.

17. The computer program product of claim 13, further comprising computer readable program code configured to present, at the computing device, identification of the plurality of contexts for user selection.

18. The computer program product of claim 13, wherein the one or more video frames are video frames of video content other than the displayed video content.

19. The computer program product of claim 13, further comprising computer readable program code configured to:
determine descriptive data associated with the displayed video content;
compare the descriptive data associated with the displayed video content with descriptive data associated with one or more other video content; and
identify the one or more video frames based on the comparison.

20. The computer program product of claim 13, further comprising computer readable program code configured to replace one or more other currently-displayed video frames with the one or more video frames.
